(19) United States
(12) Patent Application Publication
(10) Pub. No.: US 2021/0308773 A1
(43) Pub. Date: Oct. 7, 2021

(54) TURNING TOOL HOLDER

(71) Applicant: CERATIZIT AUSTRIA GESELLSCHAFT M.B.H., REUTTE (AT)

(72) Inventors: MARTIN SENZENBERGER, REUTTE (AT); REMUS VENTURINI, REUTTE (AT); CHRISTIAN GOEBERL, REUTTE (AT)

(21) Appl. No.: 17/264,933

(22) PCT Filed: Jun. 27, 2019
(86) PCT No.: PCT/AT2019/060210

§ 371 Date: Feb. 1, 2021

(30) Foreign Application Priority Data
Aug. 1, 2018 (AT) GM155/2018

(51) Int. Cl. B23B 27/10; B23Q 11/10

(52) U.S. Cl. CPC B23B 27/10; B23Q 11/1076

(57) ABSTRACT

A turning tool holder includes a clamping portion for connection to a tool fitting of a machine tool and a machining portion having a seat for an interchangeable cutting insert. An internal coolant guide in the tool holder supplies coolant to the machining portion and has a first coolant inlet and first coolant outlet laterally of the seat. The first outlet has a bore laterally of the seat extending from a surface of the machining portion for receiving an interchangeable nozzle body with a shank region in the bore and a nozzle outlet region at an angle to the shank region on the machining portion surface. An internal coolant channel extends through the shank and nozzle outlet regions. The shank region has a periphery with a recess receiving a clamping element transverse to a longitudinal axis of the shank region fastening the nozzle body to the turning tool holder.

The present invention relates to a turning tool holder and to a turning tool system having such a turning tool holder.

In the machining of workpieces, a variety of methods are used, of which working by turning is one of the most important commercially. In particular in the machining of metallic materials, a trend that can be observed in this respect is for ever more complex machining operations and ever higher machining speeds, associated with which trend are higher requirements for the cooling of the turning tool used. Materials that are increasingly more difficult to machine and likewise set higher requirements for the cooling of the turning tool are also being used.

Frequently used for the turning are turning tools in which the cutting edge which comes into engagement with the material to be machined is realized on an interchangeable cutting insert which is composed of a particularly hard and wear-resistant material, such as in particular hard metal (cemented carbide), cermet or a cutting ceramic, and is fastened to a seat on a turning tool holder of a tougher material, such as e.g. steel. In addition to a long-established technique, in which coolant is supplied into the region of the cutting edges via coolant hoses and nozzles formed separately to the turning tool,

for some years, increasingly being used are turning tools in which an internal coolant guide is realized which has at least one coolant channel running through the interior of the turning tool holder. In the present context, the term nozzle is understood here to mean a structure which allows an emergence of a directed jet, without it being necessary for this structure imperatively to have a focusing or flow velocity-increasing configuration.

When realizing an internal coolant guide in a turning tool holder, in practice the problem frequently arises that the nozzles from which the coolant emerges in a targeted manner onto the region of the cutting edge are exposed to a high degree of wear by the chips produced during the turning. In particular in the case of turning tool holders which are used for a variety of turning operations or are used under a variety of operating parameters, the problem also frequently arises that the nozzles impede an unobstructed flow of the chips produced during the turning.

It is an object of the present invention to provide a turning tool holder and a turning tool system which are cost-effective to produce, enable a specifically directed coolant supply into the region of the cutting edge, are robust and insensitive with respect to the conditions during the turning and preferably also make it possible to use what is known as microlubrication (MQL).

The object is achieved by a turning tool holder according to claim 1. Advantageous refinements are specified in the dependent claims.

The turning tool holder has a clamping portion for connection to a tool fitting of a machine tool and a machining portion having a seat for receiving an interchangeable cutting insert. Formed in the turning tool holder is an internal coolant guide for supplying coolant to the machining portion, which coolant guide has at least one first coolant inlet and at least one first coolant outlet arranged at the side of the seat on the machining portion. The coolant outlet has a bore which is arranged at the side of the seat and extends from a surface of the machining portion, and in which is inserted an interchangeable nozzle body, which has a shank region inserted in the bore and a nozzle outlet region which is formed at an angle to said shank region and is arranged on the surface of the machining portion. An internal coolant channel extends through the shank region and the nozzle outlet region that is at an angle to said shank region. The shank region has on an outer circumferential surface a recess, into which a clamping element arranged in the turning tool holder and arranged transverse to a longitudinal axis of the shank region engages, by means of which clamping element the nozzle body is fastened to the turning tool holder.

Since the nozzle body has an interchangeable form, in the case of wear it can be replaced easily and cost-effectively. If the nozzle body should get in the way spatially during the specifically intended turning, it can furthermore be removed and optionally replaced by a blind plug. Since the internal coolant channel extends through the shank portion and the nozzle outlet region that is at an angle to said shank portion, which shank portion and nozzle outlet region can be formed in one piece and/or monolithically, a particularly compact configuration is made possible. Furthermore, the internal coolant channel can be formed in this way without severe changes to the flow cross section, as a result of which an undesired drop in pressure and an undesired segregation of the coolant can be avoided. Since the nozzle body is fastened to the machining portion by way of the clamping element which is arranged in the turning tool holder and extends transverse to the longitudinal axis of the shank portion, the fastening mechanism is well protected against both chips and the coolant used. In comparison with a configuration in which e.g. the shank portion would be provided with an external thread which interacts directly with an internal thread in the bore, the nozzle body can furthermore be fastened very quickly and that part of the nozzle body which projects from the surface of the machining portion does not need to be provided with disruptive surfaces of attack for a screwing tool.

According to one refinement, the clamping element is arranged in a transverse bore which is connected to the bore in a communicating manner. In this case, a particularly well protected and compact arrangement of the fastening mechanism is realized. In this respect, the transverse bore can extend for example in particular substantially perpendicular to the bore.

According to one refinement, the transverse bore is a threaded bore with an internal thread which interacts with an external thread on the clamping element. In this case, the nozzle body can be fastened particularly quickly and reliably to the machining portion. When the clamping element is in the form of a set screw (i.e. a screw without a laterally projecting screw head), a particularly compact realization of the fastening mechanism is achieved.

According to one refinement, the recess is a groove which encircles the shank region in an annular manner. In this case, the recess can be created particularly easily and cost-effectively by turning when the nozzle body is being produced.

According to one refinement, the recess has a clamping surface which runs obliquely with respect to a longitudinal axis of the shank region and on which a holding surface of the clamping element acts in a wedge-shaped manner, with the result that the nozzle body is clamped against the surface of the machining portion. In this case, the nozzle body is fastened particularly reliably to the machining portion utilizing the principle of the oblique plane and the fastening mechanism is very insensitive to manufacturing tolerances. The clamping surface can in particular run preferably at an angle of between 20° and 70° to the longitudinal axis of the shank portion, preferably of between 35° and 55°.

According to one refinement, arranged on the surface of the machining portion is a first rotation-prevention element, which interacts with a second rotation-prevention element on a bottom side of the nozzle outlet region for the purpose of preventing rotation of the nozzle body about a longitudinal axis of the shank region. In this case, it is ensured in a particularly easy and cost-effective manner that the emerging coolant jet is directed reliably onto the intended region of the cutting insert.

When the first rotation-prevention element is a projection and the second rotation-prevention means is a depression in the bottom side of the nozzle outlet region, a particularly easy and cost-effective manufacture also of the rotation-prevention mechanism is made possible. In particular, the second rotation-prevention element can be formed by a pin, which is arranged in a further bore extending from the surface of the machining portion, which allows a particularly fast and cost-effective production of the turning tool holder. The pin can here e.g. simply be pressed into the further bore or be provided with an external thread which interacts with an internal thread in the further bore.

According to one refinement, the coolant outlet is arranged in such a way that a coolant jet emerging from the nozzle body is directed onto a rake face of a cutting insert arranged on the seat. In this case, particularly efficient cooling of the turning tool and the machined surface of the workpiece is provided.

According to one refinement, an annular sealing element is arranged between an outer circumferential surface of the shank region and an inner circumferential surface of the bore. In this case, undesired lateral emergence of the coolant is reliably prevented and the sealing element is protected reliably against damage in this respect. The sealing element can be formed e.g. by an O-ring arranged in an encircling groove. Whenever the sealing element is arranged on a side of the recess that faces away from the nozzle outlet region, the fastening mechanism for the nozzle body is also protected by the sealing element reliably against dirt and against contact with the coolant.

According to one refinement, at least one further coolant outlet with a bore extending from the surface is formed on the machining portion at the side of the seat. The further coolant outlet can preferably have a form which is a substantially identical to the first coolant outlet. The provision of the further coolant outlet makes it possible to particularly efficiently cool the cutting edge, since two coolant jets are supplied at the rake face. The further coolant outlet also makes it possible that e.g. a coolant jet is supplied into the region of the cutting edge only via the further coolant outlet and a nozzle body arranged there, instead of the first coolant outlet. In this case, it is possible that e.g. the bore of the first coolant outlet is closed by a blind plug. This can be advantageous in particular whenever the arrangement of the nozzle body in the bore of the first coolant outlet would impede the chip flow or the turning would be spatially impeded in another way.

With preference, the first coolant outlet and the further coolant outlet are formed in such a way that the nozzle body can be inserted selectively into the bore of the first coolant outlet or into the bore of the further coolant outlet. In this case, the same nozzle body can be used both at the first coolant outlet and at the further coolant outlet and optionally the same blind plug can find use, in order selectively to close the bore of the first coolant outlet or the bore of the further coolant outlet.

According to one refinement, the coolant channel formed in the nozzle body is free of abrupt changes in cross section. In this case, a severe drop in pressure of the coolant is reliably prevented by way of the nozzle body and the coolant jet can be supplied at high pressure to the region of the cutting edge. Furthermore, an undesired segregation of the coolant can be prevented, which is particularly advantageous in particular in the case of what is known as microlubrication (MQL).

According to one refinement, the coolant channel extends in a spatially curved manner through the nozzle body. The coolant channel can extend here in particular in an arcuate manner, without abrupt changes in direction, through the nozzle body. In this case, an undesirably high drop in pressure and the risk of segregation of the coolant are particularly reliably avoided.

According to one refinement, the nozzle body is formed from a different material than the remainder of the turning tool holder. With preference, the nozzle body can be formed from a harder and more wear-resistant material, such as e.g. hard metal (cemented carbide). In this case, the situation is achieved that the nozzle body does not wear as quickly even when it comes into contact with e.g. flowing chips.

The object is also achieved by a turning tool system according to claim 16.

The turning tool system has a turning tool holder as described previously and at least one blind plug, which can be inserted into the bore instead of the nozzle body in order to close said bore in a fluid-tight manner. The provision of the additional blind plug makes it possible for the first coolant outlet to be reliably closed and, if it is provided, instead using another coolant outlet if the arrangement of the nozzle body in the bore of the first coolant outlet would impede the intended turning.

Further advantages and expedient aspects of the invention will become apparent on the basis of the following description of exemplary embodiments with reference to the appended figures, in which:

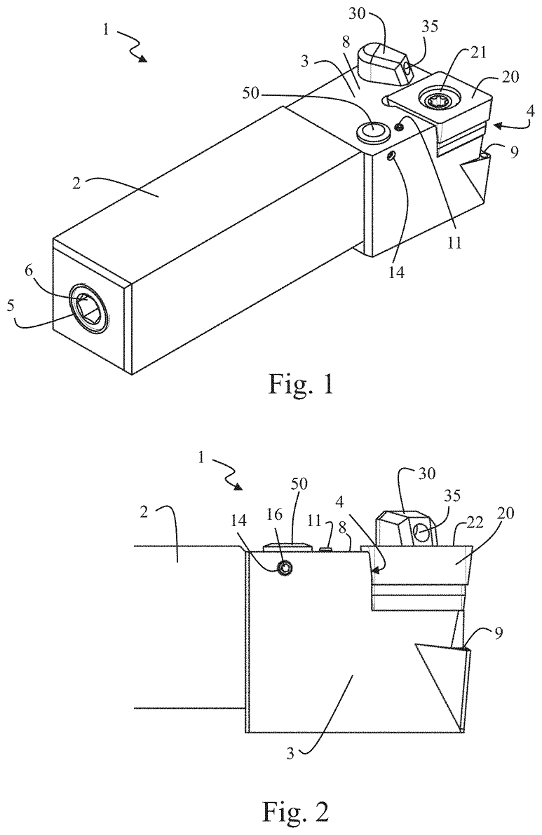

FIG. 1: shows a schematic and perspective view of a turning tool holder according to one embodiment, with a mounted nozzle body and a mounted blind plug;

FIG. 2: shows a schematic side view of the machining portion in the case of the turning tool holder from FIG. 1;

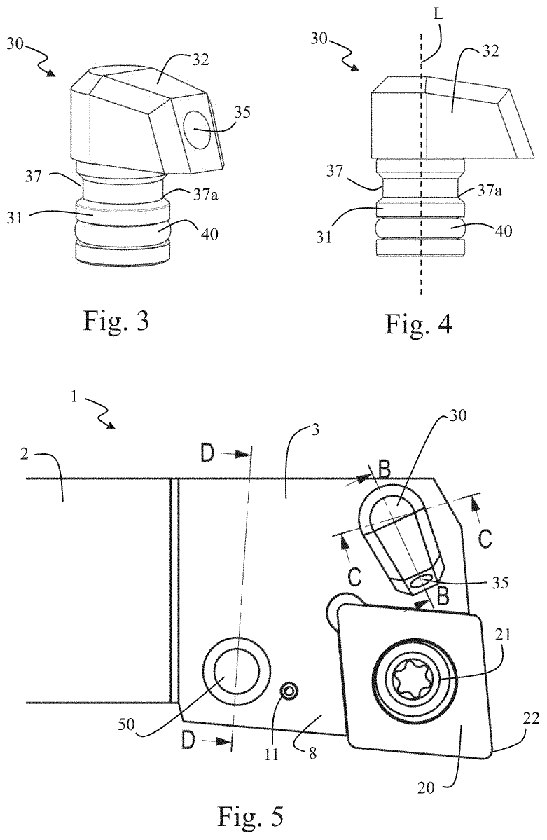

FIG. 3: shows a schematic and perspective illustration of the nozzle body;

FIG. 4: shows a schematic side view of the nozzle body;

FIG. 5: shows a schematic plan view of the machining portion in the case of the turning tool holder from FIG. 1;

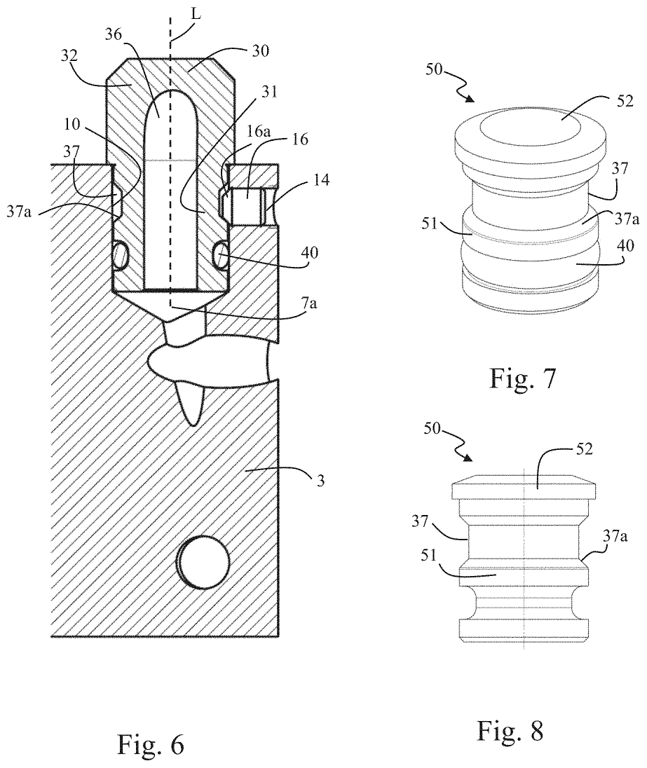

FIG. 6: shows an enlarged illustration of a detail of a section along C-C in FIG. 5;

FIG. 7: shows a schematic and perspective illustration of the blind plug;

FIG. 8: shows a schematic side view of the blind plug without a sealing element;

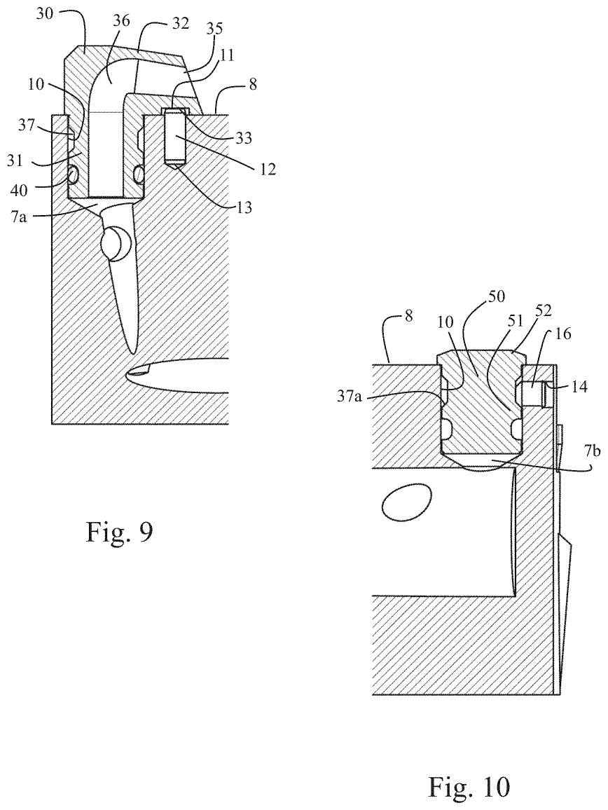

FIG. 9: shows an enlarged illustration of a detail of a section along B-B in FIG. 5;

FIG. 10: shows an enlarged illustration of a detail of a section along D-D through the blind plug in FIG. 5;

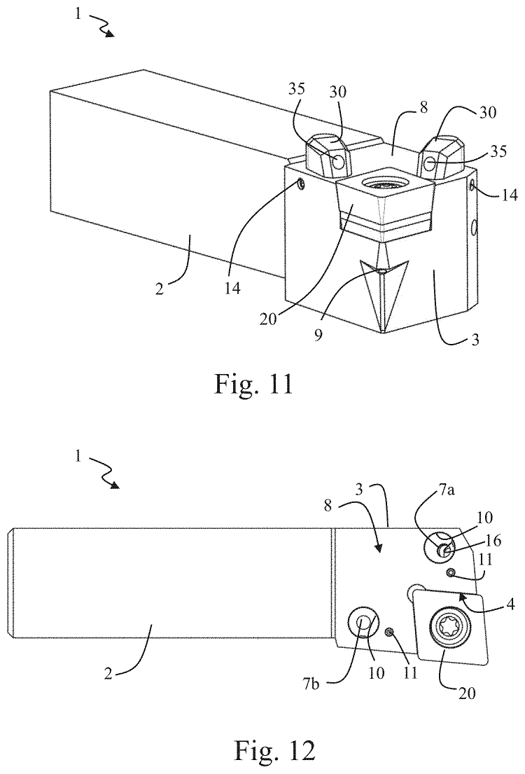

FIG. 11: shows a schematic and perspective illustration of the turning tool holder with two mounted nozzle bodies; and

FIG. 12: shows a schematic plan view of the turning tool holder without a nozzle body and without a blind plug.

One embodiment of the turning tool holder 1 is described below with reference to FIG. 1 to FIG. 12. In the example specifically illustrated, the turning tool holder 1 is in the form of what is known as a monobloc holder, however it should be taken into consideration that the turning tool holder 1 can also receive other configurations.

The turning tool holder 1 has a clamping portion 2 for clamping to a tool fitting of a machine tool and a machining portion 3, which is formed in one piece and/or monolithically with the clamping portion 2 and on which is formed a seat 4 for receiving an interchangeable cutting insert 20. The turning tool holder 1 can be formed e.g. from steel or a relatively tough hard metal. Although the specific example shows a realization in which the seat 4 is formed such that the cutting insert 20 is fastened to the seat 4 by way of a fastening screw 21, other routine configurations, such as e.g. fastening by way of a clamping shoe or the like, are also possible.

The cutting edge 22 which comes into engagement with the material to be machined is formed on the cutting insert 20 in a manner known per se. The cutting insert 20 is manufactured from a hard and wear-resistant material and can in particular be formed from hard metal (cemented carbide), cermet or a cutting ceramic. In this respect, the cutting insert 20 can in particular be in the form of an indexable insert which has a plurality of cutting-edge regions which can be used in succession.

The turning tool holder 1 has an internal coolant guide which is formed to supply coolant through the interior of the turning tool holder 1 to the machining portion 3. The internal coolant guide has at least one first coolant inlet 5, via which coolant can be supplied into the inner coolant guide. Although the embodiment illustrated illustrates only one coolant inlet 5, which is formed on an end face of the clamping portion 2, the turning tool holder 1 can preferably have a plurality of alternatively usable coolant inlets 5 which are connected in each case to the internal coolant guide in a communicating manner. The cooling inlets which are respectively specifically not required can be closed by a closure element 6, as is illustrated in FIG. 1 by way of example for the first coolant inlet 5.

As can be seen in particular in FIG. 11 and FIG. 12, the turning tool holder 1 in the example specifically illustrated has a first coolant outlet 7a and a further coolant outlet 7b, which are formed in each case on a top surface 8 of the machining portion 3 at the side of the seat 4. In the embodiment, both the first coolant outlet 7a and the second coolant outlet 7b are formed to supply coolant to a rake face of the interchangeable cutting insert 20.

As can be seen in particular in FIG. 1, FIG. 2 and FIG. 11, in the embodiment a third coolant outlet 9, which is likewise fluidically connected to the internal coolant guide and by way of which coolant can be supplied to a free surface of the cutting insert 20, is furthermore formed.

Since the first coolant outlet 7a and the further coolant outlet 7b have a substantially identical form except for their spatial position, only the first coolant outlet 7a is described in more detail below and the description applies similarly to the further coolant outlet 7b.

The first coolant outlet 7a has a bore 10, which extends proceeding from the surface 8 of the machining portion 3 into the material of the turning tool holder 1 and, by way of the internal coolant guide, is fluidically connected to the first coolant inlet 5 and optionally further coolant inlets (if they are present). In the embodiment, the bore 10 is in the form of a cylindrical bore, the longitudinal axis of which extends perpendicular to the surface 8. In the embodiment, the bore 10 is provided in particular with a smooth wall.

As can be seen in particular in FIG. 6, FIG. 9 and FIG. 11, inserted in the bore 10 of the first coolant outlet 7a is an interchangeable nozzle body 30 which is described in more detail below. The nozzle body 30 can preferably be formed from a different material than the remainder of the turning tool holder, in particular from a harder and more wear-resistant material. By way of example, the nozzle body 30 can be formed from hard metal. In this case, it is particularly resistant to wear caused by flowing chips. The nozzle body 30 is furthermore also still illustrated individually in FIG. 3 and FIG. 4. The nozzle body 30 is formed in one piece and/or monolithically and has a shank region 31, which is formed in such a way that it can be inserted into the bore 10, and a nozzle outlet region 32 formed at an angle to said shank region. The shank region 31 is formed as rotationally symmetrical with respect to a longitudinal axis L, which is illustrated schematically in FIG. 4. In the embodiment specifically illustrated, formed on the outer circumference of the shank region is an annularly encircling depression, in which an annular sealing element 40 is arranged. In the configuration illustrated, the annular sealing element 40 is realized as an O-ring of rubber. The shank region 31 and the annular sealing element 40 are dimensioned such that the shank region 31 can be inserted into the bore 10 and the annular sealing element 40 is arranged here in a sealing manner between the outer circumferential surface of the shank region 31 and the inner circumferential surface of the bore 10. In this way, the annular sealing element 40 prevents an undesired passage of coolant between the outer circumferential surface of the shank region 31 and the inner circumferential surface of the bore 10.

The nozzle outlet region 32 of the nozzle body 30 that is at an angle is designed in such a way that a bottom side of the nozzle outlet region 32 lies on the surface 8 of the machining portion 3 when the shank region 31 is inserted into the bore 10. In order to secure the nozzle body 30 in its orientation and to prevent rotation of the nozzle body 30 about the longitudinal axis L, arranged on the surface 8 of the machining portion 3 is a first rotation-prevention element 11 which interacts with a second rotation-prevention element 33 arranged on the bottom side of the nozzle outlet region 32. In the exemplary embodiment illustrated in the drawings, the second rotation-prevention element 33 is in the form of a depression in the bottom side of the nozzle outlet region 32 and the first rotation-prevention element 11 is in the form of a projection engaging into said depression, as can be seen in particular in FIG. 9. This can be realized in a particularly easy and cost-effective manner. A reversed configuration is, however, also possible, in which the first rotation-prevention element 11 is in the form of a depression and the second rotation-prevention element 33 is in the form of a projection. In the example illustrated, the first rotation-prevention element 11 is formed by a pin 12, which is inserted into a bore 13 extending from the surface 8 of the machining portion 3, which allows a particularly cost-effective realization. The pin 12 can e.g. be pressed into a smooth-walled bore 13 or the pin 12 can be provided with an external thread which interacts with a corresponding internal thread in the bore 13.

The nozzle body 30 has, on the nozzle outlet region 32, an outlet opening 35 for a coolant jet that is designed, via the interaction of the first rotation-prevention element 11 and the second rotation-prevention element 33, in such a way that the coolant jet is directed onto a rake surface of a cutting insert 20 arranged on the seat 4. As can be seen in particular in FIG. 6 and FIG. 9, extending through the shank region 31 and the nozzle outlet region 32 that is at an angle to said shank region is an internal coolant channel 36, which is formed to conduct coolant from the internal coolant guide to the outlet opening 35. The internal coolant channel 36 extends in this case in a spatially curved manner through the nozzle body 30 and is free of abrupt changes in cross section, with the result that the coolant in the nozzle body 30 is deflected smoothly in the direction of the outlet opening 35. In the shank region 31, the internal coolant channel 36 extends substantially parallel and coaxial to the longitudinal axis L.

The fastening of the nozzle body 30 in the bore 10 is described in more detail below with reference to FIG. 3, FIG. 4 and FIG. 6.

As can be seen in FIG. 3 and FIG. 4, the shank region 31 of the nozzle body 30 is provided with a recess 37. In the exemplary embodiment, the recess 37 is in the form of a groove encircling the shank region 31 in an annular manner. In the example illustrated, the groove runs around in an annular manner in particular coaxial to the longitudinal axis L, which allows a particularly easy and cost-effective manufacture. The recess 37 furthermore has a substantially trapezoidal cross-sectional profile, as can be seen in FIG. 4 and FIG. 6. As can be discerned in particular in FIG. 6, a transverse bore 14 which is connected to the bore 10 in a communicating manner is formed in the machining portion 3 of the turning tool holder 1. The transverse bore 14 extends transverse to the bore 10 and consequently also transverse to the longitudinal axis L of the shank region 31. In particular, the transverse bore 14 can extend perpendicular to the longitudinal axis L. In the exemplary embodiment, the transverse bore 14 is in the form of a threaded bore with an internal thread and extends as far as a side surface of the machining portion 3.

Arranged in the transverse bore 14 is a clamping element 16, which is formed to engage into the recess 37 on the shank region 31 in order to fasten the nozzle body 30 to the machining portion 3. The clamping element 16 is provided with an external thread which interacts with the internal thread in the transverse bore 14. A side of the clamping element 16 that faces away from the bore 10 is provided with an engaging structure for a screwing tool, via which engaging structure the clamping element 16 can be actuated by a screwing tool, which is inserted into the transverse bore from the side surface of the machining portion 3. The engaging structure can e.g. be in the form of a slot for a flat-tipped screwdriver, a cross recess, a hexagonal socket, or the like. In the embodiment specifically illustrated, the clamping element 16 is in the form of a set screw.

As can be seen in FIG. 6, on the shank region 31 of the nozzle body 30, the recess 37 has a clamping surface 37a which runs obliquely with respect to the longitudinal axis L of the shank region 31 and is brought about by the trapezoidal cross-sectional profile of the recess 37. The clamping surface 37a is aligned obliquely here in such a manner that it departs from the longitudinal axis L as the distance from the nozzle outlet region 32 increases, thus the outer circumference of the shank region 31 widens as the distance from the nozzle outlet region 32 increases. That end face of the clamping element 16 which faces the bore 10 is laterally bevelled and/or chamfered, with the result that a holding surface 16a that likewise runs obliquely with respect to the longitudinal axis L is formed. The outer circumference of the clamping element 16 thus tapers in the direction of the bore 10. The position of the recess 37 on the shank portion 31 and the position of the transverse bore 14 are matched to one another such that the holding surface 16a of the clamping element 16 acts on the clamping surface 37a of the recess 37 in a wedge-shaped manner in accordance with the principle of the oblique plane in such a way that the nozzle body 30 is drawn into the bore 10 when the clamping element 16 is screwed into the transverse bore 14. In this way, the nozzle body 30 is clamped against the surface 8 of the machining portion 3, as a result of which the first rotation-prevention element 11 and the second rotation-prevention element 33 are also held in form-locking engagement.

The recess 37 is arranged on the shank region 31 between the nozzle outlet region 32 and the annular sealing element 40 such that the clamping mechanism formed by the clamping element 16 and the recess 37 is arranged in a manner protected from the coolant.

The further coolant outlet 7b is designed correspondingly to the first coolant outlet 7a. Consequently, a bore 10 and a transverse bore 14 are likewise provided with a clamping element 16 and, on the surface 8 of the machining portion 3, a first rotation-prevention element 11 is also provided there.

On account of the corresponding configuration of the first coolant outlet 7a and the further coolant outlet 7b, the nozzle body 30 can be inserted selectively into the bore 10 of the first coolant outlet 7a or into the bore 10 of the further coolant outlet 7b. It is also e.g. possible to insert a nozzle body 30 in each case both into the bore 10 of the first coolant outlet 7a and into the bore 10 of the second coolant outlet 7b, as illustrated e.g. in FIG. 11. When the intention is to use only one nozzle body 30, which e.g. can be the case if the arrangement of a nozzle body 30 in the bore 10 of the first coolant outlet 7a or in the bore 10 of the further coolant outlet 7b would have a spatially disruptive effect during the turning, the bore 10 of the first coolant outlet 7a or the bore 10 of the further coolant outlet 7b can be closed by a blind plug 50, which is also described below. Illustrated in FIG. 1, FIG. 2, FIG. 5 and FIG. 10 in each case is a situation in which the further coolant outlet 7b is closed in a fluid-tight manner by means of a blind plug 50.

When the intention is to use neither the first coolant outlet 7a nor the second coolant outlet 7b, both of said coolant outlets can be closed by respective blind plugs 50.

The blind plug 50 is illustrated in FIG. 8 in a side view without an annular sealing element 40, and in FIG. 7 in a perspective view with an annular sealing element 40 arranged thereon. The blind plug 50 has a shank region 51, the outer circumferential surface of which has a form which is substantially identical to the shank region 31 of the nozzle body 30, as can be seen in FIG. 7 and FIG. 8. For the purpose of simplification, the annular sealing element 40 is not illustrated in FIG. 10. The shank region 51 of the blind plug has a recess 37 with a clamping surface 37a and an encircling depression in which the annular sealing element 40 is received. Instead of the nozzle outlet region 32, in the case of the nozzle body 30 the blind plug 50 has a flat cover region 52, which has a somewhat larger cross section than the bore 10 and is formed as flat in such a way that it does not protrude to a great extent from the surface 8 of the machining portion 3 when the shank portion 51 is received in the bore 10.

On account of the substantially identical configuration of the shank region 51 of the blind plug 50 and the shank region 31 of the nozzle body 30, the blind plug 50 can be fastened in the same way to the clamping element 16 in the bore 10 of the first coolant outlet 7a and in the bore of the second coolant outlet 7b, as was previously described for the nozzle body 30.

1-16. (canceled)

17. A turning tool holder, comprising:
a clamping portion for connection to a tool fitting of a machine tool;
a machining portion having a seat for receiving an interchangeable cutting insert, said machining portion having a surface;
an internal coolant guide formed in the turning tool holder for supplying coolant to said machining portion, said coolant guide having at least one first coolant inlet and at least one first coolant outlet disposed laterally of said seat on said machining portion;
said first coolant outlet having a bore disposed laterally of said seat and extending from said surface of said machining portion;
an interchangeable nozzle body configured to be inserted in said bore of said first coolant outlet, said interchangeable nozzle body having a shank region inserted into said bore of said first coolant outlet and a nozzle outlet region formed at an angle to said shank region and disposed on said surface of said machining portion;
an internal coolant channel extending through said shank region and said nozzle outlet region;
said shank region having an outer circumferential surface, a longitudinal axis and a recess formed in said outer circumferential surface; and
a clamping element configured to be engaged in said recess transverse to said longitudinal axis of said shank region for fastening said nozzle body to the turning tool holder.

18. The turning tool holder according to claim 17, wherein said clamping element is disposed in a transverse bore connected to and communicating with said bore of said first coolant outlet.

19. The turning tool holder according to claim 18, wherein said transverse bore is a threaded bore with an internal thread interacting with an external thread on said clamping element.

20. The turning tool holder according to claim 17, wherein said recess is a groove annularly encircling said shank region.

21. The turning tool holder according to claim 17, wherein said recess forms a clamping surface running obliquely relative to said longitudinal axis of said shank region, and said clamping element has a wedge-shaped holding surface for clamping said nozzle body against said surface of said machining portion.

22. The turning tool holder according to claim 17, which further comprises a first rotation-prevention element disposed on said surface of said machining portion, and a second rotation-prevention element disposed on a bottom side of said nozzle outlet region, said first rotation-prevention element interacting with said second rotation-prevention element for preventing rotation of said nozzle body about said longitudinal axis of said shank region.

23. The turning tool holder according to claim 22, wherein said first rotation-prevention element is a projection and said second rotation-prevention means is a depression in said bottom side of said nozzle outlet region.

24. The turning tool holder according to claim 17, wherein said first coolant outlet is configured to direct a coolant jet emerging from said nozzle body onto a rake face of a cutting insert disposed on said seat.

25. The turning tool holder according to claim 17, which further comprises an annular sealing element disposed between said outer circumferential surface of said shank region and an inner circumferential surface of said bore.

26. The turning tool holder according to claim 25, wherein said sealing element is disposed on a side of said recess facing away from said nozzle outlet region.

27. The turning tool holder according to claim 17, which further comprises at least one second coolant outlet having a bore formed in said machining portion laterally of said seat and extending from said surface.

28. The turning tool holder according to claim 27, wherein said first coolant outlet and said second coolant outlet are formed to permit said nozzle body to be inserted selectively into said bore of said first coolant outlet or into said bore of said of said second coolant outlet.

29. The turning tool holder according to claim 17, wherein said internal coolant channel formed in said nozzle body is free of abrupt changes in cross section.

30. The turning tool holder according to claim 29, wherein said internal coolant channel extends in a spatially curved manner through said nozzle body.

31. The turning tool holder according to claim 17, wherein said nozzle body is formed of a different material than a remainder of the turning tool holder.

32. A turning tool system, comprising:
a turning tool holder according to claim 17; and
at least one blind plug configured to be inserted into said bore instead of said nozzle body in order to fluid-tightly close said bore.
